(19) United States
(12) Patent Application Publication
(10) Pub. No.: US 2014/0355572 A1
(43) Pub. Date: Dec. 4, 2014

(54) METHOD AND APPARATUS FOR AUTOMATIC GAIN CONTROL FOR TD-SCDMA SYSTEMS

(71) Applicants: Aamod Dinkar Khandekar, San Diego, CA (US); Srikanth Gummadi, San Diego, CA (US); Kang Wang, Beijing (CN); Minkui Liu, San Diego, CA (US)

(72) Inventors: Aamod Dinkar Khandekar, San Diego, CA (US); Srikanth Gummadi, San Diego, CA (US); Kang Wang, Beijing (CN); Minkui Liu, San Diego, CA (US)

(73) Assignee: QUALCOMM Incorporated, San Diego, CA (US)

(21) Appl. No.: 14/128,353

(22) PCT Filed: Jul. 25, 2011
(86) PCT No.: PCT/CN2011/077549

§ 371 Date: Jul. 28, 2014

(51) Int. Cl. H04W 74/08; H04W 52/52

(52) U.S. Cl. CPC H04W 74/0891; H04W 52/52
USPC 370/336

(57) ABSTRACT

A method and apparatus in wireless communications is provided. The method may include measuring received powers levels for a first window of samples, and computing a gain value based on the measured received powers levels. The method may also include determining an offset duration such that the first window of samples and a second window of samples both are included within a downlink region that has downlink power within a threshold level. The method may additionally include applying the gain value to the second window of samples, and the second window of samples may occur after the offset duration.

### FIELD

The present application relates generally to wireless communications, and more specifically to methods and apparatus for optimizing automatic gain control of a received signal at a user equipment (UE) in a Time Division Synchronous Code Division Multiple Access (TD-SCDMA) wireless communications system.

### BACKGROUND

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and TD-SCDMA. For example, China is pursuing TD-SCDMA as the underlying air interface in the UTRAN architecture with its existing GSM infrastructure as the core network. The UMTS also supports enhanced 3G data communications protocols, such as High Speed Downlink Packet Data (HSDPA), which provides higher data transfer speeds and capacity to associated UMTS networks.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more aspects and corresponding disclosure thereof, various aspects are described in relation to optimizing automatic gain control (AGC) of a received signal at a UE in a TD-SCDMA wireless communications system. According to one aspect, a method in wireless communications is provided. The method can comprise measuring received powers levels for a first window of samples, and computing a gain value based on the measured received powers levels. The method can also comprise determining an offset duration such that the first window of samples and a second window of samples both are included within a downlink region that has downlink power within a threshold level and applying the gain value to the second window of samples. The second window of samples may occur after the offset duration.

Another aspect relates to an apparatus. The apparatus can include at least one processor configured to measure received powers levels for a first window of samples, and compute a gain value based on the measured received powers levels. The at least one processor may be further configured to determine an offset duration such that the first window of samples and a second window of samples both are included within a downlink region that has downlink power within a threshold level. The at least one process may be further configured to apply the gain value to the second window of samples, and the second window of samples may occur after the offset duration.

Another aspect relates to a computer program product comprising a computer-readable medium. The computer-readable medium comprising code for measuring received powers levels for a first window of samples, and computing a gain value based on the measured received powers levels. Further, the computer-readable medium may comprise code for determining an offset duration such that the first window of samples and a second window of samples both are included within a downlink region that has downlink power within a threshold level and applying the gain value to the second window of samples. The second window of samples may occur after the offset duration.

Yet another aspect relates to an apparatus. The apparatus may comprise means for measuring received powers levels for a first window of samples, and means for computing a gain value based on the measured received powers levels. Further, the apparatus can comprise means for determining an offset duration such that the first window of samples and a second window of samples both are included within a downlink region that has downlink power within a threshold level and means for applying the gain value to the second window of samples. The second window of samples may occur after the offset duration.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 depicts a block diagram of an example TD-SCDMA wireless communications environment, according to an aspect;

FIG. 2 depicts an example frame structure in a TD-SCDMA wireless communications system, according to an aspect;

FIG. 3 depicts an example TD-SCDMA based wireless communications system with multiple UEs communicating with a Node B, as time progresses, according to an aspect;

FIG. 4 depicts an example Digital Variable Gain Adjustment (DVGA) algorithm in acquisition mode for a UE, according to an aspect;

FIG. 5 depicts an example flowchart of a methodology for implementing the DVGA algorithm for a UE in FIG. 4, according to an aspect;

FIG. 6 depicts a block diagram of an example UE for facilitating the DVGA algorithm for a UE in FIGS. 4 and 5, according to an aspect;

FIG. 7 depicts a block diagram of a design of a base station and a UE in a TD-SCDMA wireless communications system, according to an aspect; and

FIG. 8 depicts a block diagram representing functions implemented by a processor, software, or combination thereof can reside at least partially within a UE, according to an aspect.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

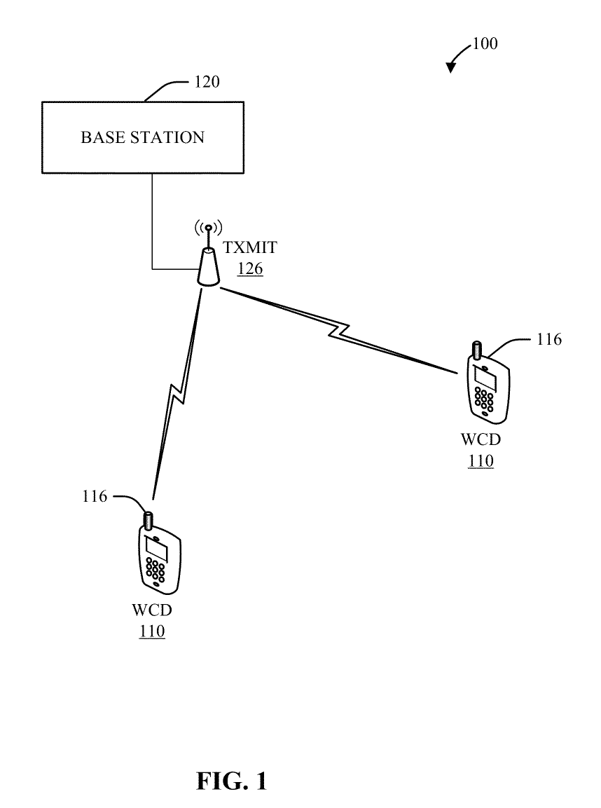

With reference now to FIG. 1, a block diagram of an example TD-SCDMA system 100 is illustrated. System 100 may include one or more base stations 120 (e.g. Node-B, E-Node-B, etc.) and one or more user equipments (UEs) 110 (e.g. wireless communications devices (WCD), terminals, etc.), which can communicate via respective antennas 126 and 116. In one aspect, a target base station 120 may conduct a DL communication to each UE 110 via antennas 126. In one aspect, UE 110 may receive DL communications received via antennas 116. Further UE 110 may attempt to conduct uplink (UL) communications to target base station 120 via antennas 116. At the target base station 120, UL communications may be received via antennas 126.

In a TD-SCDMA system, UL and DL traffic can share the same frequency band, but with different time slots (TSs). As a result, TD-SCDMA is well suited for asymmetric data services with high spectral efficiency. Key techniques employed in TD-SCDMA systems may include multiplexing, smart antennas, and joint detection techniques.

In one aspect, multicarrier techniques have been used with TD-SCDMA to increase data capacity and transmission rates in support of high data rate wireless services. A multicarrier TD-SCDMA system may employ three different frequencies as the carrier frequency for a given cell. In particular, one of these frequencies is designated the primary carrier; while the others are called secondary carriers. The difference between the primary carrier and the secondary carriers is whether pilot and broadcast channel (BCH) information is carried therewith. That is, the primary carrier handles pilot and BCH information; while the secondary carriers do not. The paging indicator channel (PICH) and secondary common control physical channel (SCCPCH) may be configured in the primary carrier.

In an aspect, the secondary frequency may be randomly selected. Generally, since a DL pilot signal may be transmitted on a primary frequency, secondary frequencies may not experience other base station DL communication interference on a secondary frequency. As used herein, a primary frequency may refer to a frequency used by a target base station 120 to transmit a DL pilot signal using a downlink pilot channel (DwPCH). Further, any secondary frequency of N secondary frequencies may describe any frequency that the target base station 120 is not using as a primary frequency.

In some examples, a cell searching process needs to be performed when a UE in the communication systems is powered on or the cell is re-selected. For example, in each UE 110, the TSs of one subframe may be received at the working carrier frequency and AGC is immediately performed. However, received power of each TS within the same subframe varies greatly, thereby making the design of an AGC algorithm quite challenging.

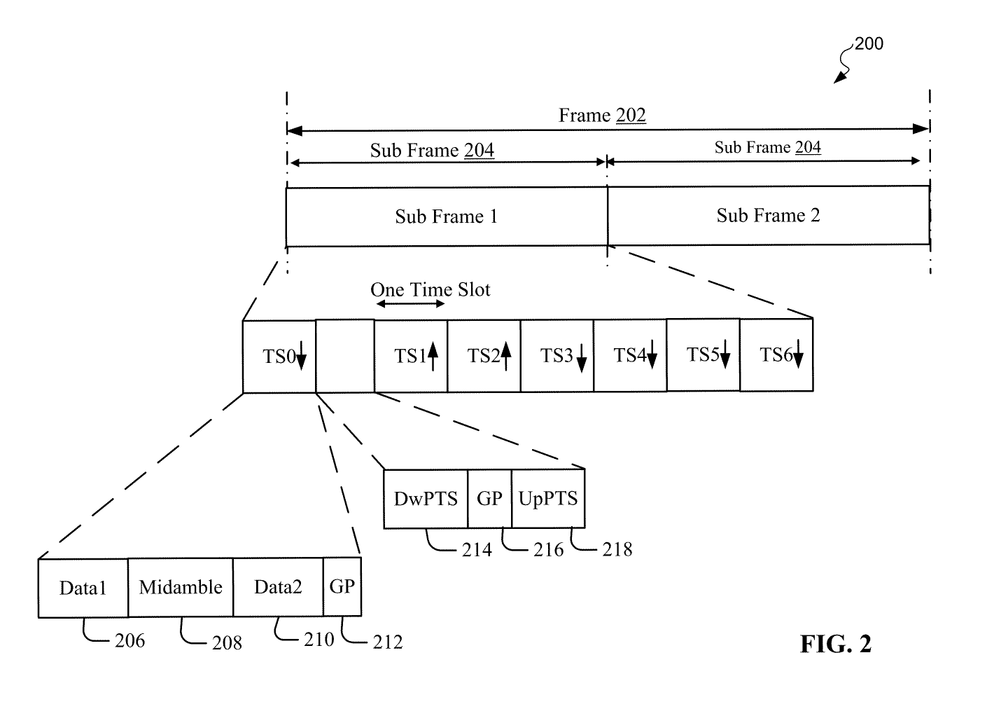

With reference to FIG. 2 an example frame structure 200 of a TD-SCDMA wireless communications system is depicted. Each TD-SCDMA frame 202 may be divided into two 5 ms subframes 204, each including 7 traffic TSs TS0-TS6 and three special timeslots: DwPTS (downlink pilot timeslot) 214, UpPTS (uplink pilot timeslot) 216 and GP (guard period) 218. In one aspect, TS0 is used for carrying downlink data, TS1 is used for carrying uplink data, and TS2-TS6 can be used for respectively carrying data in uplink or downlink. Each traffic TS0-TS7 may be 675 μs in duration or 864 chips. Each TS may be divided into 4 fields, including data field 1 206 (352 chips), midamble field 208 (144 chips), data field 2 210 (352 chips) and GP 212 (16 chips).

Among the three special TSs, DwPTS 214 (96 chips) is located after the TS0, for carrying downlink pilot and synchronization channel code or namely downlink synchronization code (SYNC_DL). UpPTS 218 (160 chips) can be used for carrying uplink pilot and synchronization channel code or namely uplink synchronization code (SYNC_UL), to establish uplink synchronization between a UE and a Node B. GP 216 may be 96 chips and used for guarding Tx propagation delay during uplink establishment procedure.

As discussed above, SYNC_DL in DwPTS 214, SYNC_UL in UpPTS 218 and midamble 208 in traffic TS may be given in form of chip rate, and can be delivered later along with the baseband processed and spread data directly without being baseband processed, spread and scrambled. In some implementations, DwPTS 214 can be transmitted at an approximately constant power level that can ensure omni-direction coverage of the overall cell, so that all UEs in the cell can receive the synchronization information.

Moreover, SYNC_DL, SYNC_UL and midamble can be found in 3GPP specifications and thus need not be generated additionally. According to 3GPP specifications, there are 32 SYNC_DL codes, 256 SYNC_UL codes, 128 midamble codes and 128 scrambling codes defined for a TD-SCDMA system. All these codes may be classified into 32 groups, with each group having one SYNC_DL codes, 8 SYNC_UL codes, 4 midamble codes and 4 scrambling codes. Different adjacent cells use different code groups. For a UE, if the SYNC_DL code used by its cell is known, the four midamble codes used by its cell can also be decided. In some examples, one midamble code is used in ordinary cells, and the other three are reserved for different operators. Further, the 144 chips carried on the midamble field can be generated through cyclic shift based on the basic midamble codebook in 3GPP specifications. Midamble codes used by different channels in the same timeslot may be obtained by intercepting different areas of the cycled basic midamble codebook, and different midamble shifts are usually denoted by m (1) m (2) . . . m (m).

In a practical TD-SCDMA system, user data and control information can be delivered in physical channels, and each physical channel may be defined by many factors such as frequency, timeslot, channel code, midamble shift, allocation of radio frames and etc. Some physical channels at particular locations in the subframe will have particular physical characteristics, such as beacon characteristic. The so-called beacon characteristic means that the transmission characteristics can be analyzed and measured according to the features of the physical channel. Physical channels with beacon characteristic are also called as beacon channel.

In a TD-SCDMA system, beacon channel appears in TS0 of each sub-frame, because common control physical channel is fixedly located in TS0 and uses some fixed parameters. For example, the beacon channel can use the first and second channelization codes in TS0. If no antenna diversity is applied in the cell, the primary common control channel (PCCCH) will use m(1). If antenna diversity is applied in the cell, the PCCCH will use m(1) on the first antenna and m(2) on the second antenna. Because TS0 uses fixed midamble code, users can easily obtain the midamble code used by the cell in TS0 after obtaining SYNC_DL during cell search procedure.

The detailed procedure for cell search may be as follows: the UE may first find the most powerful frequency through measuring the broadband power of each carrier frequency in TDD frequency band. Subsequently, the UE may receive information at the frequency and searches DwPTS 214 for determining SYNC_DL of the cell. More specifically, searching of SYNC_DL is generally performed by first determining the TS position according to DwPTS 214 power characteristic, and then to determine SYNC_DL used by the cell and its accurate position by using, e.g., a match filter. After SYNC_DL used by the cell is known, the four midamble codes used by the cell can also be determined. Because fixed channelization codes are used in TS0, the four midamble codes configured for the cell can be used in turn to compute channel impulse responses, and the maximum value one will be determined as the midamble code used by the cell, and thus the corresponding scrambling code can be determined.

After a cell search procedure is completed, the midamble code in TS0 and SYNC_DL in DwPTS 214 at this frequency can be determined. In one example, as shown in FIG. 2, between midamble code of TS0 and SYNC_DL, there are data field 2 210 (352 chips), GP 212 (16 chips) and another GP in DwPTS (32 chips), which add up to 352+16+32=400 chips. The known signals of the midamble and SYNC_DL can be obtained accurately, and the time interval between the midamble and SYNC_DL can be forecast according to the communication specifications. The 504 chips may include: a) 72 chips in the midamble: the middle 128 chips in the midamble (144 chips) are selected for correlation operation, and the 16 chips remained are evenly located at the two sides of the 128 chips, so there are 72 (64+8=72) chips from the middle of the midamble to data field 2 210; b) 352 chips of data field 2 210; c) 16 chips for GP 212 between data field 2 and DwPTS; d) 32 chips for GP preceding SYNC_DL in DwPTS; e) 32 chips of SYNC_DL: there are 32 chips from the end of GP in DwPTS to the middle of SYNC_DL (64 chips). Among the 72+352+16+32+32=504 chips, correlation operation may be applied to the 128-chip midamble and 64-chip SYNC_DL.

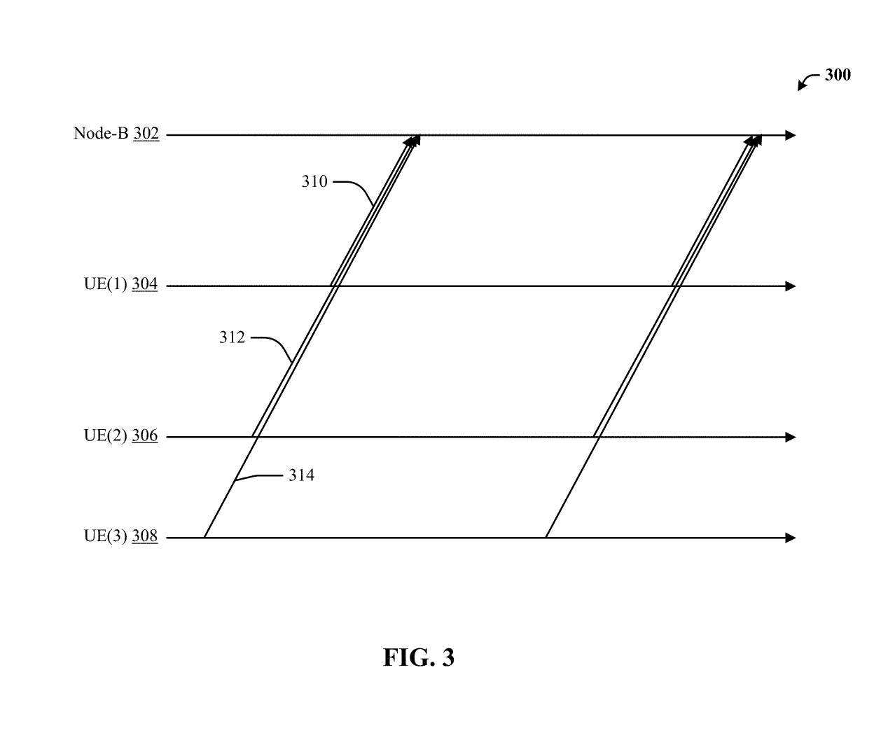

Turning now to FIG. 3, an example TD-SCDMA based system 300 with multiple UEs (304, 306, 308) communicating with a Node B 302, as time progresses, is illustrated. Generally, in TD-SCDMA systems, multiple UEs may share a common bandwidth in communication with a Node B 302. Additionally, one aspect in TD-SCDMA systems, as compared to CDMA and WCDMA systems, is UL synchronization. That is, in TD-SCDMA systems, different UEs (304, 306, 308) may synchronize on the uplink (UL) such that all UE (304, 306, 308) transmitted signals arrives at the Node B (NB) at approximately the same time. For example, in the depicted aspect, various UEs (304, 306, 308) are located at various distances from the serving Node B 302. Accordingly, in order for the UL transmission to reach the Node B 302 at approximately the same time, each UE may originate transmissions at different times. For example, UE 308 may be farthest from Node B 302 and may perform an UL transmission 314 before closer UEs. Additionally, UE 306 may be closer to Node B 302 than UE 308 and may perform an UL transmission 312 after UE 308. Similarly, UE 304 may be closer to Node B 302 than UE 306 and may perform an UL transmission 310 after UEs 306 and 308. The timing of the UL transmissions (310, 312, 314) may be such that the signals arrive at the Node B at approximately the same time.

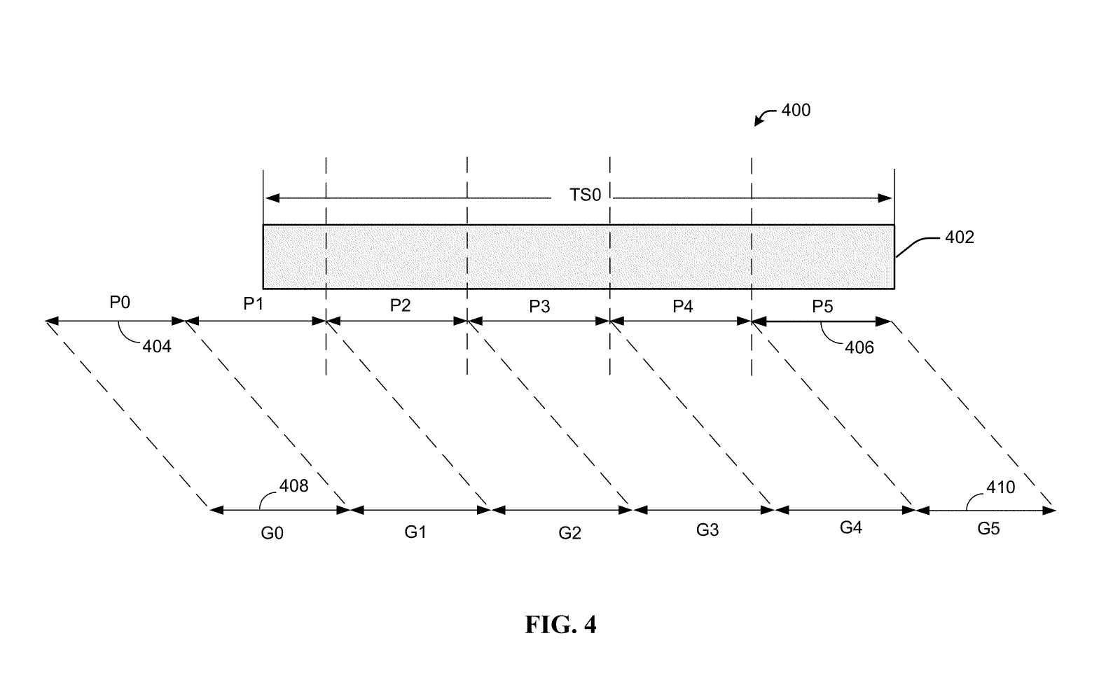

Referring to FIG. 4, an example DVGA algorithm 400 in acquisition mode at a UE is illustrated according to an aspect of present disclosure. AGC algorithm may include a digital component (e.g., DVGA) and an analog component (referred to as analog gain state control).

It is understood that in acquisition mode, the UL/DL boundaries and subframe and TS boundaries may be unknown to the UE, and large variations in received power are possible at these slot boundaries. As such, the DVGA algorithms in this mode can be implemented to select an appropriate and approximately constant gain on the TS0 midamble and the DwPTS regions, such that the post-DVGA samples cannot saturate, and cannot suffer from a poor Signal-to-Quantization-Noise Ratio (SQNR).

In addition, it is desirable that the DwPTS or the TS0 midamble signals do not yield two significantly different gain values which may result in degradation in the correlation output. There is no SQNR and/or saturation requirement for signals other than the DwPTS and the TS0 midamble. Therefore, an arbitrary gain setting can be employed excluding these two specific regions.

As shown in FIG. 4, received power of a detected TS0 402 at a UE is measured in a plurality of consecutive time intervals Pᵢ (P0 404 through P5 406). Gain values Gᵢ (G0 408 through G5 410) are then computed based on corresponding measured power level Pᵢ to facilitate the DVGA of the TS0 402 midamble and the subsequent DwPTS (now shown). This implementation is based on the fact that the specification may guarantee that the first two codes of TS0 402 have an approximately constant pre-defined transmit power, and there is no beamforming used on these two codes or the transmitting of the subsequent DwPTS. Therefore, the DwPTS may have a fixed received power relationship with respect to the first two codes of TS0. In addition, it is expected that the total received power of TS0 402 is at most 9 dB less than that of DwPTS, as the first two codes of TS0 can be sent at least at nominal power spectral density. As discussed above, initial acquisition at a UE depends on the information included in the midamble of TS0 (e.g., the central part of TS0 which contains a pilot) and the DwPTS. Therefore, it is crucial that these signals are received at a UE with minimal or no distortion. Further, it is desirable that the gain on these signals be based on the measurement of a single signal (e.g., TS0 402) as opposed to a combination of the TS0 and the DwPTS so as to prevent signal distortion. As will be described below in details, an optimal AGC algorithm and procedure at a UE can be achieved by, e.g., determining proper locations and durations of power measurement and AGC gain application window of at least a portion of a received DL time slot. It is also useful to set an appropriate delay between these two operations to facilitate fast and reliable processing of the received signal.

Consecutive power measurement intervals Pᵢ in FIG. 4 may comprise power measurements carried out on input samples prior to DVGA application. As shown in FIG. 4, since the UE has not acquired frame timing at this stage, these Pᵢ intervals may not be aligned to the slot/subframe boundary.

Gain application windows Gᵢ are also back-to-back intervals, each having a duration of 128 chips. The gain application windows Gᵢ may be aligned such that the start of the gain application window Gᵢ may occur 96 chips (or 75 μs) after the end of the power measurement window Pᵢ, and the 75 μs gap may provide sufficient processing time to compute the power, compute the gain, and subsequently apply the gain.

The relation between the power measurement Pᵢ (corresponding to measurement window Pᵢ) and the gain value Gᵢ (corresponding to application window Gᵢ) may be given by Gᵢ, where Gᵢ is equal to square root of K/Pᵢ. In some examples, both Pᵢ and Gᵢ may be in linear scale. However, either Pᵢ or Gᵢ may be expressed in log domain in some embodiments. For example, the power measurement Pᵢ may be provided in linear scale, and the gain value Gᵢ may be provided in logarithmic scale with base 2. A factor of 0.5 may be needed to carry out the conversion between power and amplitude. K is a configurable scaling factor.

The DVGA algorithm described above may have the following properties.

Consider a sample received at time t, where t is measured in units of chips. This sample falls within a gain application window [g, g+128), where g≦t<g+128. The corresponding power measurement window may be given by [g−224, g−96). Thus any sample P in the power measurement window may satisfy the following properties:

p≧g−224>t−128−224=t−352, and a.

p<g−96≦t−96. b.
In other words, t−352<p<t−96.

Since the distance between the beginning of the slot and the beginning of TS0 402 midamble is equal to 352 chips, any power measurement used in setting the gain of TS0 402 midamble can be derived entirely from samples within TS0 402.

Since the distance between the end of (non-zero samples in) the TS0 402 and the end of the DwPTS is given by 64+48=112=96+16 chips, any power measurement used in setting the gain of DwPTS may be derived approximately entirely from samples within TS0 402, except that at most 16 chips fall out of TS0 (in the gap between TS0 and DwPTS) with the rest of the samples falling within TS0. The loss of 16 chips in the power measurement may correspond to a measured power difference of up to 0.57 dB.

In some implementations, obtained samples of at least one of the TS0 402 midamble or the DwPTS may be stored in, e.g., a sample server storage. In some implementations, samples of at least one of the TS0 402 midamble or the DwPTS may be obtained in one subframe after corresponding power measurement and AGC gain application. Additionally or in the alternative, samples of at least one of the TS0 402 midamble or the DwPTS may be obtained in a subsequent subframe (e.g., 5 ms later) after the power measurement and AGC gain application have been performed.

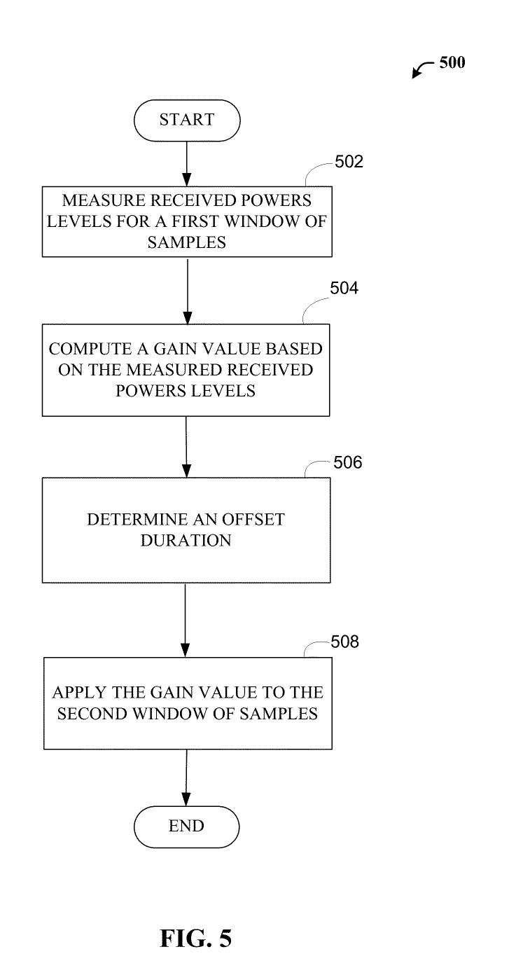

FIG. 5 depicts a flowchart 500 of a methodology for implementing the DVGA algorithm for a UE in FIG. 4. Example operations may start at block 502 in which a UE receives and detects a data frame from, e.g., a Node B, in a DL transmission, and measures received powers levels for a selected first window of samples. For example, the UE may locate a TS0 time slot or a DwPTS in which the received power levels over the entire TS0 time slot and DwPTS are maintained within a threshold level. The detected TS0 time slot can include multiple data fields and a midamble as shown in FIG. 2. At block 504, the UE may compute a gain value based on the measured received powers levels. In some examples, the gain value Gᵢ may be equal to square root of K/Pᵢ, in which K is a scaling factor, and P is the measured power level in each of the first window of samples. At block 506, the UE may determine an offset duration such that the first window of samples and a second window of samples which occurs after the offset duration both are included within a downlink region that has downlink power within a threshold level (e.g., the located TS0 time slot and DwPTS). In some implementations, each of the first and second windows lasts 128 chips, and may or may not be aligned with the boundaries of the slot/subframe boundary. The offset duration can be located within a subframe. Yet, in some other examples, the offset duration may be located in a consecutive, different subframe which is 5 ms later than the subframe in which the power levels of the first window of samples are measured. The UE, at block 508, may apply the gain value to the second window of samples. In some aspects, the UE may further store the samples in a buffer (e.g., sample server storage), and aggregate multiple stored samples for initial acquisition processing.

While, for purposes of simplicity of explanation, the methodology is shown and described as a series of acts or sequence steps, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be needed to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

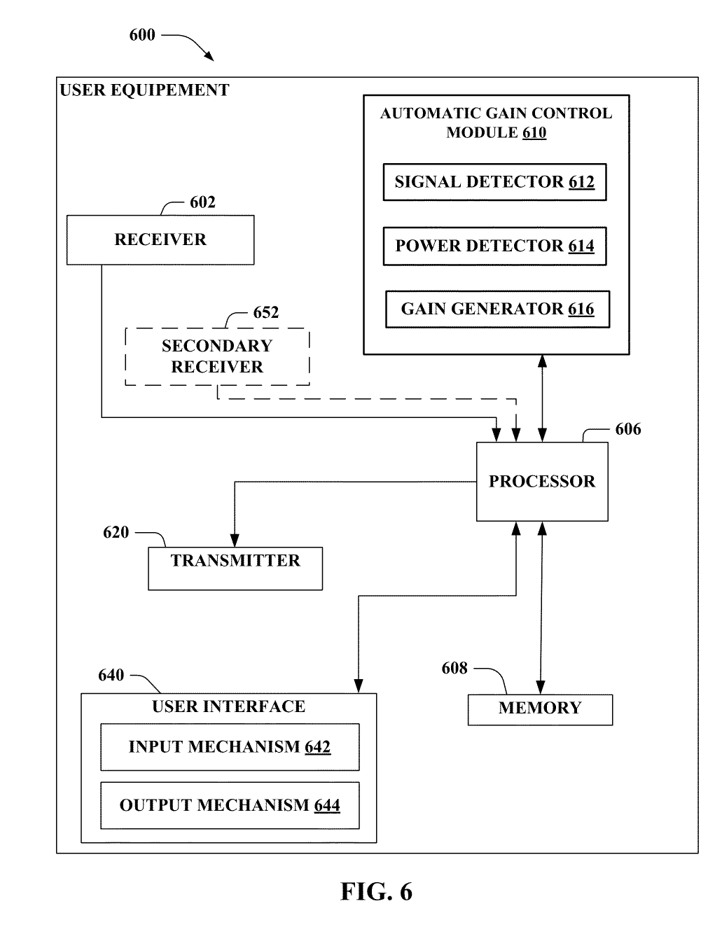

FIG. 6 shows an example UE 600 (e.g. a client device, wireless communications device (WCD) etc.) that may implement the DVGA algorithm of FIGS. 4 and 5 in accordance with present disclosure. UE 600 comprises receiver 602 that receives one or more signals from, for instance, one or more receive antennas (not shown), performs typical actions on (e.g., filters, amplifies, downconverts, etc.) the received signal, and digitizes the conditioned signal to obtain samples. Receiver 602 can further comprise an oscillator that can provide a carrier frequency for demodulation of the received signal and a demodulator that can demodulate received symbols and provide them to processor 606 for channel estimation. In one aspect, UE 600 may further comprise secondary receiver 652 and may receive additional channels of information.

Processor 606 can be a processor dedicated to analyzing information received by receiver 602 and/or generating information for transmission by one or more transmitters 620 (for ease of illustration, only one transmitter is shown), a processor that controls one or more components of UE 600, and/or a processor that both analyzes information received by receiver 602 and/or receiver 652, generates information for transmission by transmitter 620 for transmission on one or more transmitting antennas (not shown), and controls one or more components of UE 600. In one aspect of UE 600, processor 606 may include at least one processor and memory, wherein the memory may be within the at least one processor 606. By way of example and not limitation, the memory could include on-board cache or general purpose register.

UE 600 can additionally comprise memory 608 that is operatively coupled to processor 606 and that can store data to be transmitted, received data, information related to available channels, data associated with analyzed signal and/or interference strength, information related to an assigned channel, power, rate, or the like, and any other suitable information for estimating a channel and communicating via the channel. Memory 608 can additionally store protocols and/or algorithms associated with estimating and/or utilizing a channel (e.g., performance based, capacity based, etc.).

It will be appreciated that the data store (e.g., memory 608) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory 608 of the subject systems and methods is intended to comprise, without being limited to, these and any other suitable types of memory.

UE 600 can further have an AGC module 610 that assists the UE 600 with initial acquisition. In one aspect, AGC module 610 may include one or more signal detector 612 to detect a DL time slot (e.g., TS0 and DwPTS) in a received subframe. A power detector 614 may be used to provide consecutive power measurements Pᵢ in defined time intervals of a selected first window of samples as described above to a gain generator 616. The gain generator 616 in turn can calculate and provide corresponding gain values Gᵢ in connection with each power measurement Pᵢ to the processor 606. Based on the gain values, the AGC module 610 together with the processor 606 can determine an offset duration such that the first window of samples and a subsequent second window of samples both are includes within a DL region that has DL power within a threshold level. The AGC module 610 and the processor 606 may apply the gain value to the second window of samples.

Additionally, UE 600 may include user interface 640. User interface 640 may include input mechanisms 642 for generating inputs into WCD 600, and output mechanism 642 for generating information for consumption by the user of UE 600. For example, input mechanism 642 may include a mechanism such as a key or keyboard, a mouse, a touch-screen display, a microphone, etc. Further, for example, output mechanism 644 may include a display, an audio speaker, a haptic feedback mechanism, a Personal Area Network (PAN) transceiver etc. In the illustrated aspects, output mechanism 644 may include a display operable to present content that is in image or video format or an audio speaker to present content that is in an audio format.

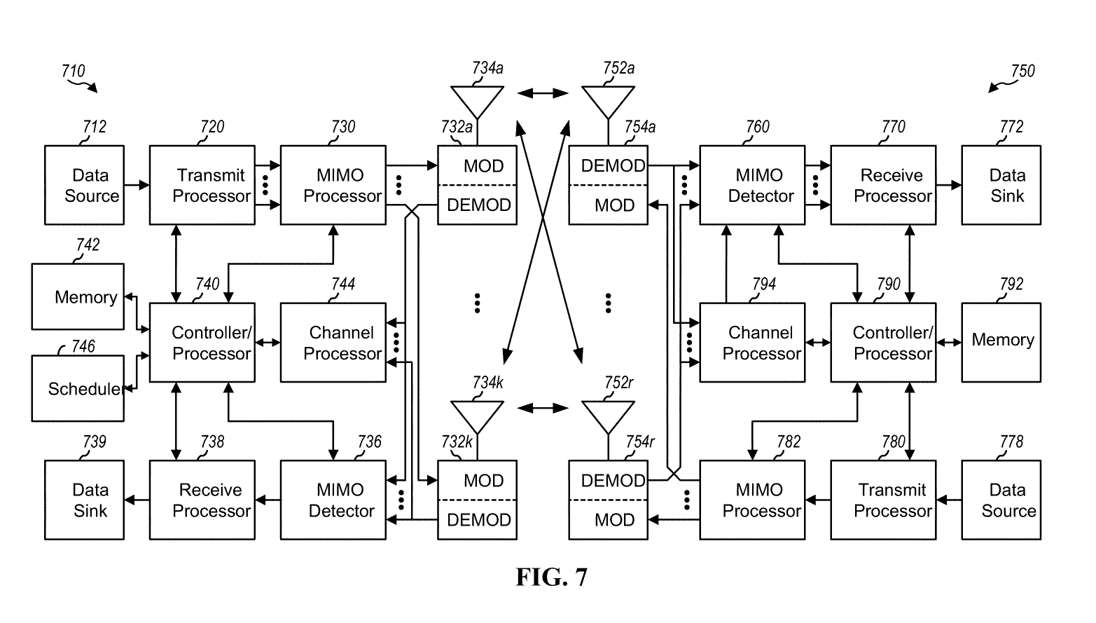

FIG. 7 shows a block diagram of a design of a base station 710 and a UE 750. A base station may also be referred to as a Node B, an evolved Node B (eNB), an access point, etc. A UE may also be referred to as a mobile station, a terminal, an access terminal, a subscriber unit, a station, etc. A UE may be a cellular phone, a personal digital assistant (PDA), a wireless modem, a wireless communication device, a handheld device, a laptop computer, a cordless phone, etc. In the design shown in FIG. 7, base station 710 is equipped with K antennas 734a through 734k, and UE 750 is equipped with R antennas 752a through 752r, where in general K≧1 and R≧1 .

At base station 710, a transmit processor 720 may receive data for one or more UEs from a data source 712, process (e.g., encode and modulate) the data for each UE based on one or more modulation and coding schemes for that UE, and provide data symbols for all UEs. Transmit processor 720 may also generate control symbols for control information. Transmit processor 720 may further generate reference/pilot symbols for one or more reference signals. In a TD-SCDMA system, a multiple-input-multiple-output (MIMO) processor 730 may perform precoding on the data symbols, the control symbols, and/or the reference symbols, if applicable, and may provide K output symbol streams to K modulators (MOD) 732a through 732k. Each modulator 732 may process its output symbol stream (e.g., for OFDM) to obtain an output sample stream. Each modulator 732 may further condition (e.g., convert to analog, filter, amplify, and upconvert) its output sample stream and generate a downlink signal. K downlink signals from modulators 732a through 732k may be transmitted via antennas 734a through 734k, respectively.

At UE 750, R antennas 752a through 752r may receive the K downlink signals from base station 710, and each antenna 752 may provide a received signal to an associated demodulator (DEMOD) 754. Each demodulator 754 may condition (e.g., filter, amplify, downconvert, and digitize) it's received signal to obtain samples and may further process the samples (e.g., for OFDM) to obtain received symbols. Each demodulator 754 may provide received data symbols to a MIMO detector 760 and provide received reference symbols to a channel processor 794. Channel processor 794 may estimate the response of the downlink channel from base station 710 to UE 750 based on the received reference symbols and may provide a channel estimate to MIMO detector 760. MIMO detector 760 may perform MIMO detection on the received data symbols based on the channel estimate and provide symbol estimates, which may be estimates of the transmitted symbols. A receive processor 770 may process (e.g., demodulate and decode) the symbol estimates based on the modulation and coding scheme(s) used for UE 750, provide decoded data to a data sink 772, and provide decoded control information to a controller/processor 790.

UE 750 may estimate the downlink channel response and generate channel feedback information, which may comprise reported channel vectors. UE 750 may also estimate the downlink channel quality and determine channel quality indicator (CQI) information. Feedback information (e.g., the channel feedback information, CQI information, etc.), data from a data source 778, and a reference signal may be processed (e.g., encoded and modulated) by a transmit processor 780, precoded by a MIMO processor 782, if applicable, and further processed by modulators 754a through 754r to generate R uplink signals, which may be transmitted via antennas 752a through 752r. At base station 710, the R uplink signals from UE 750 may be received by K antennas 734a through 734k and processed by demodulators 732a through 732k. A channel processor 744 may estimate the response of the uplink channel from UE 750 to base station 710 and may provide a channel estimate to MIMO detector 736. MIMO detector 736 may perform MIMO detection based on the channel estimate and provide symbol estimates. A receive processor 738 may process the symbol estimates, provide decoded data to a data sink 739, and provide decoded feedback information to a controller/processor 740. Controller/processor 740 may control data transmission to UE 750 based on the feedback information.

Controllers/processors 740 and 790 may direct the operation at base station 710 and UE 750, respectively. Processor 794, processor 790 and/or other processors and modules at UE 750 may perform or direct process 500 in FIG. 5, and/or other processes for the techniques described herein. Processor 744, processor 740 and/or other processors and modules at base station 710 may also perform or direct process 500 in FIG. 5, and/or other processes for the techniques described herein. Memories 742 and 792 may store data and program codes for base station 710 and UE 750, respectively. A scheduler 746 may select UE 750 and/or other UEs for data transmission on the downlink and/or uplink based on the feedback information received from the UEs.

In one aspect, processor 790 may be operable to provide means for measuring received powers levels for a first window of samples. In another aspect, processor 790 may provide means for computing a gain value based on the measured received powers levels. In another aspect, processor 790 may provide means for determining an offset duration such that the first window of samples and a second window of samples both are included within a downlink region that has downlink power within a threshold level. In another aspect, processor 790 may provide means for applying the gain value to the second window of samples, wherein the second window of samples occurs after the offset duration.

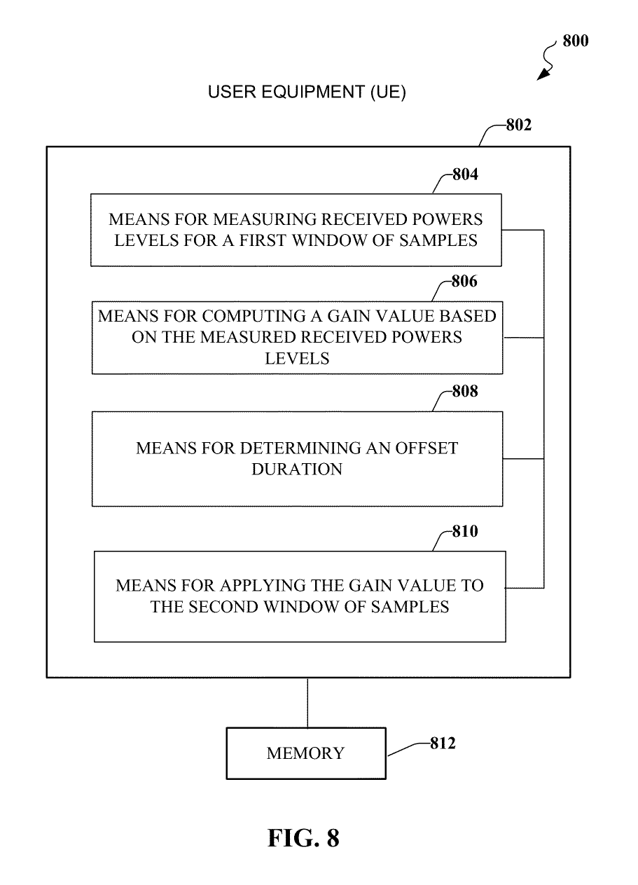

Referring to FIG. 8, an apparatus 800 which includes functional blocks representing functions implemented by a processor, software, or combination thereof (e.g., firmware) can reside at least partially within a UE. As such, apparatus 800 includes a logical grouping 802 of electrical components that can act in conjunction. For instance, logical grouping 802 can include means for measuring received powers levels for a first window of samples (Block 804). In an aspect, the means 804 can include, e.g., receiver 602, processor 606, signal detector 612, and power detector 614 in FIG. 6. Further, logical grouping 802 can include means for computing a gain value based on the measured received powers levels (Block 806). In an aspect, the means 806 can include, e.g., processor 606 in FIG. 6. Also, logical grouping 802 can include means for determining an offset duration such that the first window of samples and a second window of samples both are included within a downlink region that has downlink power within a threshold level (Block 808). In an aspect, the means 808 can include, e.g., processor 606 in FIG. 6. In addition, logical grouping 802 can include means for applying the gain value to the second window of samples, wherein the second window of samples occurs after the offset duration (Block 810). In an aspect, the means 810 can include, e.g., processor 606, memory 608 and AGC module 610 in FIG. 6.

Additionally, apparatus 800 can include a memory 812 that retains instructions for executing functions associated with electrical components 804, 806, 808 and 810. While shown as being external to memory 812, it is to be understood that one or more of electrical components 804, 806, 808 and 810 can exist within memory 812. While shown as being external to memory 812, it is to be understood that one or more of the means 804, 806, 808 and 810 can exist within memory 812.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

Information and signals may be represented using any of a variety of different technologies and techniques. For example, data, instructions, commands, information, signals and the like that may be referenced throughout the above description may be represented by voltages, currents, electromagnetic waves, magnetic fields or particles, optical fields or particles or any combination thereof.

The various illustrative logic blocks, modules and circuits described in connection with the present disclosure may be implemented or performed with a general purpose processor, a digital signal processor (DSP), an application specific integrated circuit (ASIC), a field programmable gate array signal (FPGA) or other programmable means device (PLD), discrete gate or transistor means, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The steps disclosed in the example algorithms may be interchanged in their order without departing from the scope and spirit of the present disclosure. Also, the steps illustrated in the example algorithms are not exclusive and other steps may be included or one or more of the steps in the example algorithms may be deleted without affecting the scope and spirit of the present disclosure.

The methods disclosed herein comprise one or more steps or actions for achieving the described method. The method steps and/or actions may be interchanged with one another without departing from the scope and spirit of the present disclosure. The method steps and/or actions are not exclusive and other method steps and/or actions may be included or one or more method steps and/or actions may be deleted without affecting the scope and spirit of the present disclosure. In other words, unless a specific order of steps or actions is specified, the order and/or use of specific steps and/or actions may be modified without departing from the scope and spirit of the disclosure.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-Ray® disc where disks usually reproduce data magnetically, while discs reproduce data optically with lasers.

While various aspects of the present disclosure have been described herein, each with one or more technical features, those skilled in the art will appreciate that different technical features of the various aspects described herein may also be combined resulting in various combinations not explicitly described herein. Further, certain aspects may involve multiple technical features, one or more of which may be omitted, again resulting in various combinations of one or more technical features not explicitly described herein.

As an example, while certain aspects may provide a method (and corresponding apparatus) for wireless communications generally including measuring received powers levels for a first window of samples, computing a gain value based on the measured received powers levels, determining an offset duration such that the first window of samples and a second window of samples both are included within a downlink region that has downlink power within a threshold level, and applying the gain value to the second window of samples, wherein the second window of samples occurs after the offset duration, exactly how the measuring, computing, determining and applying is performed may vary according to different aspects.

It is to be understood that the claims are not limited to the precise configuration and components illustrated above. Various modifications, changes and variations may be made in the arrangement, operation and details of the methods and apparatus described above without departing from the scope and spirit of the present disclosure.

What is claimed is:

1. A method in wireless communications, comprising:
measuring received powers levels for a first window of samples;
computing a gain value based on the measured received powers levels;
determining an offset duration such that the first window of samples and a second window of samples both are included within a downlink region that has downlink power within a threshold level; and
applying the gain value to the second window of samples, wherein the second window of samples occurs after the offset duration.

2. The method of claim 1, wherein the downlink region comprises at least a TS0 time slot and a Downlink Pilot Time Slot (DwPTS) in a Time Division Synchronous Code Division Multiple Access (TD-SCDMA) system.

3. The method of claim 1, wherein each of the first window and the second window lasts 128 chips.

4. The method of claim 1, wherein the offset duration is located in a first subframe.

5. The method of claim 4, wherein the offset duration is located in a second, consecutive subframe which is 5 ms later than the first subframe.

6. The method of claim 1, wherein the wireless communications are performed in a TD-SCDMA system.

7. The method of claim 6, wherein the method is used for initial acquisition in the TD-SCDMA system.

8. The method of claim 1, further comprising:
storing the first window and the second window of samples in a buffer; and
aggregating multiple stored samples for initial acquisition processing.

9. The method of claim 2, wherein the TS0 time slot comprises a midamble and a received power level for the midamble is less than a received power for the DwPTS.

10. The method of claim 9, wherein a difference between the received power of the midamble and the DwPTS is at most 9 dB.

11. An apparatus for wireless communications, comprising:
at least one processor configured to:
measure received powers levels for a first window of samples;
compute a gain value based on the measured received powers levels;
determine an offset duration such that the first window of samples and a second window of samples both are included within a downlink region that has downlink power within a threshold level; and
apply the gain value to the second window of samples, wherein the second window of samples occurs after the offset duration.

12. The apparatus of claim 11, wherein the downlink region comprises at least a TS0 time slot and a Downlink Pilot Time Slot (DwPTS) in a Time Division Synchronous Code Division Multiple Access (TD-SCDMA) system.

13. The apparatus of claim 11, wherein each of the first window and the second window lasts 128 chips.

14. The apparatus of claim 11, wherein the offset duration is located in a first subframe.

15. The apparatus of claim 14, wherein the offset duration is located in a second, consecutive subframe which is 5 ms later than the first subframe.

16. The apparatus of claim 11, wherein the wireless communications are performed in a TD-SCDMA system.

17. The apparatus of claim 16, wherein the apparatus is used for initial acquisition in the TD-SCDMA system.

18. The apparatus of claim 11, wherein the at least one processor is further configured to:
store the first window and the second window of samples in a buffer; and
aggregate multiple stored samples for initial acquisition processing.

19. The apparatus of claim 12, wherein the TS0 time slot comprises a midamble and a received power level for the midamble is less than a received power for the DwPTS.

20. The apparatus of claim 19, wherein a difference between the received power of the midamble and the DwPTS is at most 9 dB.

21. A computer program product, comprising:
a computer-readable medium comprising code for:
measuring received powers levels for a first window of samples;
computing a gain value based on the measured received powers levels;
determining an offset duration such that the first window of samples and a second window of samples both are included within a downlink region that has downlink power within a threshold level; and
applying the gain value to the second window of samples, wherein the second window of samples occurs after the offset duration.

22. The computer program product of claim 21, wherein the downlink region comprises at least a TS0 time slot and a Downlink Pilot Time Slot (DwPTS) in a Time Division Synchronous Code Division Multiple Access (TD-SCDMA) system.

23. The computer program product of claim 21, wherein each of the first window and the second window lasts 128 chips.

24. The computer program product of claim 21, wherein the offset duration is located in a first subframe.

25. The computer program product of claim 21, wherein the offset duration is located in a second, consecutive subframe which is 5 ms later than the first subframe.

26. The computer program product of claim 21, wherein the wireless communications are performed in a TD-SCDMA system.

27. The computer program product of claim 26, wherein the computer program product is used for initial acquisition in the TD-SCDMA system.

28. The computer program product of claim 21, wherein the computer-readable medium further comprises code for:
store the first window and the second window of samples in a buffer; and
aggregate multiple stored samples for initial acquisition processing.

29. The computer program product of claim 22, wherein the TS0 time slot comprises a midamble and a received power level for the midamble is less than a received power for the DwPTS.

30. The computer program product of claim 29, wherein a difference between the received power of the midamble and the DwPTS is at most 9 dB.

31. An apparatus for wireless communications, comprising:
means for measuring received powers levels for a first window of samples;
means for computing a gain value based on the measured received powers levels;
means for determining an offset duration such that the first window of samples and a second window of samples both are included within a downlink region that has downlink power within a threshold level; and
means for applying the gain value to the second window of samples, wherein the second window of samples occurs after the offset duration.

32. The apparatus of claim 31, wherein the downlink region comprises at least a TS0 time slot and a Downlink Pilot Time Slot (DwPTS) in a Time Division Synchronous Code Division Multiple Access (TD-SCDMA) system.

33. The apparatus of claim 31, wherein each of the first window and the second window lasts 128 chips.

34. The apparatus of claim 31, wherein the offset duration is located in a first subframe.

35. The apparatus of claim 34, wherein the offset duration is located in a second, consecutive subframe which is 5 ms later than the first subframe.

36. The apparatus of claim 31, wherein the wireless communications are performed in a TD-SCDMA system.

37. The apparatus of claim 36, wherein the apparatus is used for initial acquisition in the TD-SCDMA system.

38. The apparatus of claim 31, further comprising:
means for storing the first window and the second window of samples in a buffer; and
means for aggregating multiple stored samples for initial acquisition processing.

39. The apparatus of claim 32, wherein the TS0 time slot comprises a midamble and a received power level for the midamble is less than a received power for the DwPTS.

40. The apparatus of claim 39, wherein a difference between the received power of the midamble and the DwPTS is at most 9 dB.
